(19) United States
(12) Patent Application Publication
(10) Pub. No.: US 2016/0117040 A1
(43) Pub. Date: Apr. 28, 2016

(54) TOUCH DISPLAY APPARATUS AND METHOD FOR DETECTING TOUCH POINT THEREOF

(71) Applicant: Acer Incorporated, New Taipei City (TW)

(72) Inventor: Jin-Ting Kuo, New Taipei City (TW)

(21) Appl. No.: 14/735,159

(22) Filed: Jun. 10, 2015

(30) Foreign Application Priority Data
Oct. 28, 2014 (TW) 103137203

(51) Int. Cl. G06F 3/041; G06F 3/044

(52) U.S. Cl. CPC G06F 3/0416; G06F 3/0412; G06F 3/044

(57) ABSTRACT

A touch display apparatus and a method for detecting a touch point thereof are provided. The method for detecting a touch point includes the following steps. In a first touch detecting period, a first driving signal is provided sequentially to a plurality of first touch electrodes so that a plurality of first detecting signals are received from a plurality of second touch electrodes, and a first touch reference point is determined accordingly. In a second touch detecting period, when the first touch reference point is detected, capacitance variations of the first touch electrodes and the second touch electrodes are detected to obtain a plurality of second detecting signals and a plurality of third detecting signals, and a first real touch point is determined accordingly.

### CROSS-REFERENCE TO RELATED APPLICATION

This application claims the priority benefit of Taiwan application serial no. 103137203, filed on Oct. 28, 2014. The entirety of the above-mentioned patent application is hereby incorporated by reference herein and made a part of this specification.

### BACKGROUND OF THE INVENTION

1. Field of the Invention

The invention relates to a touch apparatus and a method for detecting a touch point thereof, and particularly to a touch display apparatus and a method for detecting a touch point thereof.

2. Description of Related Art

As information technology, wireless mobile communication and information appliances have been rapidly developed in recent years, input apparatuses for many information products have been changed from conventional keyboards and mice to touch panels for the purposes of convenience, miniaturization, and being user-friendly. Among them, touch panels are operated by finger touching. Under different operating conditions, detecting manners or parameters of touch panels may accordingly vary. However, how to accurately detect a touch point of a finger is still an important subject in designing a driving circuit of a touch panel.

### SUMMARY OF THE INVENTION

The invention provides a touch display apparatus and a method for detecting a touch point thereof, by which sensitivity and accuracy of the touch display apparatus are improved.

The touch display apparatus of the invention includes a display apparatus and a touch apparatus. The touch apparatus includes a plurality of first touch electrodes, a plurality of second touch electrodes, a first touch driving circuit and a touch detecting circuit. The first touch electrodes and the second touch electrodes are interlaced with each other to form a touch area, wherein the touch area overlaps a display area of the display apparatus. The first touch driving circuit is coupled to the first touch electrodes. The touch detecting circuit is coupled to the first touch electrodes, the second touch electrodes and the first touch driving circuit, and controls the first touch driving circuit. In a first touch detecting period, the touch detecting circuit provides a first driving signal sequentially to the first touch electrodes via the first touch driving circuit in order to receive a plurality of first detecting signals from the second touch electrodes, and the touch detecting circuit determines at least one first touch reference point according to timing of provision of the first driving signal and the first detecting signals. In a second touch detecting period, when the touch detecting circuit detects the at least one first touch reference point, the touch detecting circuit detects capacitance variations of the first touch electrodes and the second touch electrodes in order to obtain a plurality of second detecting signals and a plurality of third detecting signals, so as to determine at least one first real touch point according to the second detecting signals, the third detecting signals and the at least one first touch reference point.

In an embodiment of the invention, the first touch electrodes and the second touch electrodes are perpendicular to and interlaced with each other.

In an embodiment of the invention, the first touch detecting period and the second touch detecting period overlap a frame scanning period of the display apparatus.

In an embodiment of the invention, the display apparatus includes an active array substrate, a color filter substrate, a pixel array and a display driving circuit. The color filter substrate is assembled together with the active array substrate. The pixel array is disposed on the active array substrate and configured to form the display area. The display driving circuit is disposed on the active array substrate and coupled to the pixel array in order to drive the pixel array.

In an embodiment of the invention, the first touch driving circuit is disposed on the active array substrate, and the first touch electrodes and the second touch electrodes are disposed on the color filter substrate.

In an embodiment of the invention, the display driving circuit and the first touch driving circuit each include a plurality of shift registers.

In an embodiment of the invention, the display driving circuit provides an operation synchronizing signal to the touch detecting circuit.

In an embodiment of the invention, the touch display apparatus further includes a second touch driving circuit coupled to the second touch electrodes. In a third touch detecting period, the touch detecting circuit provides a second driving signal sequentially to the second touch electrodes via the second touch driving circuit in order to receive a plurality of fourth detecting signals from the first touch electrodes, and the touch detecting circuit determines at least one second touch reference point according to timing of provision of the second driving signal and the fourth detecting signals. In a fourth touch detecting period, when the touch detecting circuit detects the at least one second touch reference point, the touch detecting circuit detects the capacitance variations of the first touch electrodes and the second touch electrodes in order to obtain a plurality of fifth detecting signals and a plurality of sixth detecting signals, so as to determine at least one second real touch point according to the fifth detecting signals, the sixth detecting signals and the at least one second touch reference point.

The method for detecting a touch point of a touch display apparatus of the invention includes the following steps. In a first touch detecting period, a first driving signal is provided sequentially to a plurality of first touch electrodes via a first touch driving circuit so that a plurality of first detecting signals are received from a plurality of second touch electrodes, and at least one first touch reference point is determined by a touch detecting circuit according to timing of provision of the first driving signal and the first detecting signals, wherein the first touch electrodes and the second touch electrodes are interlaced with each other to form a touch area. In a second touch detecting period, when the at least one first touch reference point is detected, capacitance variations of the first touch electrodes and the second touch electrodes are detected by the touch detecting circuit in order to obtain a plurality of second detecting signals and a plurality of third detecting signals, and according to the second detecting signals, the third detecting signals and the at least one first touch reference point, at least one first real touch point is determined

In an embodiment of the invention, the first touch detecting period and the second touch detecting period overlap a frame scanning period of a display apparatus of the touch display apparatus.

In an embodiment of the invention, when the capacitance variations represented by the second detecting signal and the third detecting signal corresponding to each first touch reference point are equal to or more than a capacitance threshold, the each first touch reference point is saved as the first real touch point. When the capacitance variation represented by one of the second detecting signal and the third detecting signal corresponding to each first touch reference point is less than the capacitance threshold, the each first touch reference point is removed. In the above, the second detecting signal and the third detecting signal corresponding to each first touch reference point are respectively the second detecting signal and the third detecting signal outputted by the first touch electrode and the second touch electrode corresponding to the each first touch reference point.

In an embodiment of the invention, the method for detecting a touch point of a touch display apparatus further includes: in a third touch detecting period, a second driving signal is provided sequentially to the second touch electrodes via a second touch driving circuit so that a plurality of fourth detecting signals are received from the first touch electrodes, and at least one second touch reference point is determined by the touch detecting circuit according to timing of provision of the second driving signal and the fourth detecting signals; and in a fourth touch detecting period, when the at least one second touch reference point is detected, the capacitance variations of the first touch electrodes and the second touch electrodes are detected by the touch detecting circuit in order to obtain a plurality of fifth detecting signals and a plurality of sixth detecting signals, and at least one second real touch point is determined according to the fifth detecting signals, the sixth detecting signals and the at least one second touch reference point.

Based on the above, in the touch display apparatus and the method for detecting a touch point thereof according to embodiments of the invention, firstly, a touch point is determined by mutual capacitance detection, and then whether the touch point is a real touch point is confirmed by self capacitance detection. Accordingly, sensitivity and accuracy of the touch display apparatus are improved.

To make the above features and advantages of the invention more comprehensible, embodiments accompanied with drawings are described in detail as follows.

### BRIEF DESCRIPTION OF THE DRAWINGS

FIG. 1A and FIG. 1B are schematic diagrams of a structure of a touch display apparatus according to an embodiment of the invention.

FIG. 2 is a schematic diagram of a structure of an active array substrate according to another embodiment of the invention.

FIG. 3 is a flow chart of a method for detecting a touch point of a touch display apparatus according to an embodiment of the invention.

### DESCRIPTION OF DISCLOSED EMBODIMENTS

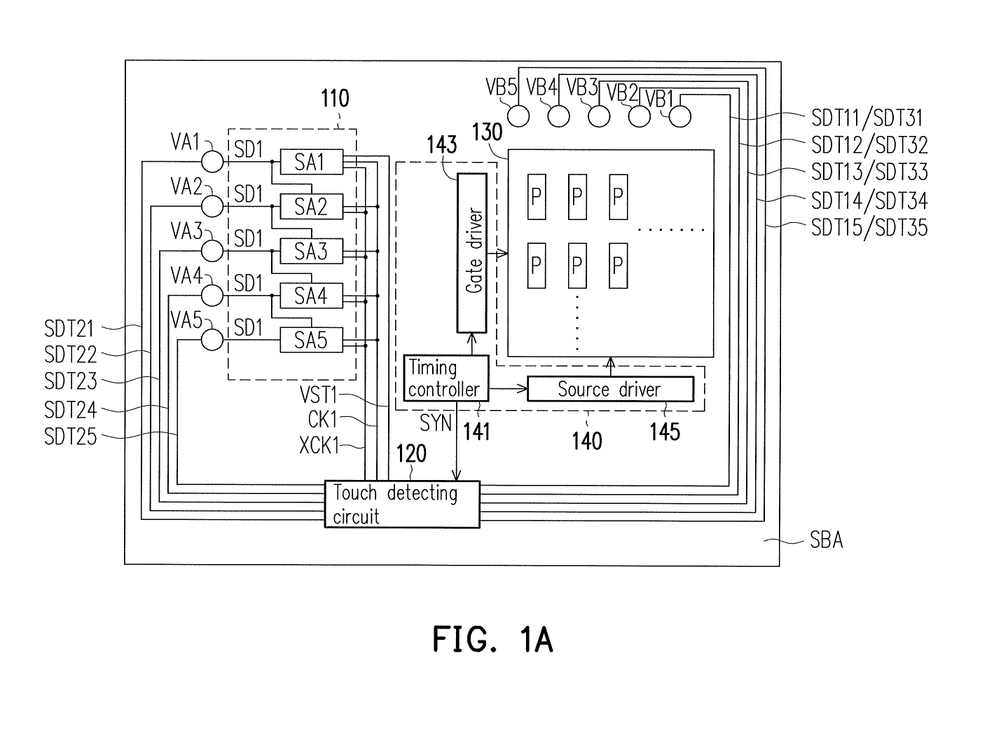

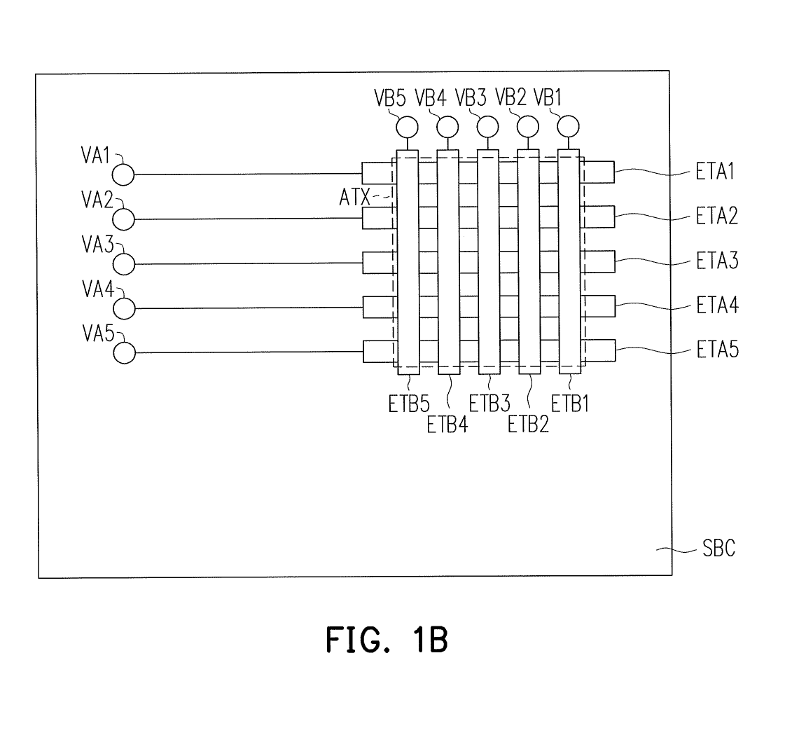

FIG. 1A and FIG. 1B are schematic diagrams of a structure of a touch display apparatus according to an embodiment of the invention. Referring to FIG. 1A and FIG. 1B, in the present embodiment, the touch display apparatus includes a display apparatus and a touch apparatus, wherein the touch apparatus at least includes a first touch driving circuit 110, a touch detecting circuit 120, a plurality of first touch electrodes (e.g., ETA1˜ETA5) and a plurality of second touch electrodes (e.g., ETB1˜ETB5), and the display apparatus at least includes an active array substrate SBA, a pixel array 130, a display driving circuit 140 and a color filter substrate SBC.

The first touch electrodes ETA1˜ETA5 and the second touch electrodes ETB1˜ETB5 are disposed on the color filter substrate SBC and are perpendicular to and interlaced with each other to form a touch area ATX, wherein the touch area ATX overlaps a display area (i.e., an area where the pixel array 130 is disposed) of the display apparatus. The first touch driving circuit 110 is disposed on the active array substrate SBA, coupled to the touch detecting circuit 120, and also coupled to the first touch electrodes ETA1˜ETA5 by vias VA1˜VA5. The first touch driving circuit 110 is activated by a control signal (e.g., start signal STV1 and clock signals CK1 and XCK1) provided by the touch detecting circuit 120. That is, activating the first touch driving circuit 110, the touch detecting circuit 120 controls the first touch driving circuit 110 provides a first driving signal SD1 sequentially to the first touch electrodes ETA1˜ETA5.

The touch detecting circuit 120 is coupled to the first touch electrodes ETA1˜ETA5 by the vias VA1˜VA5, and also coupled to the second touch electrodes ETB1˜ETB5 by vias VB1˜VB5. In a first touch detecting period, the touch detecting circuit 120 provides the first driving signal SD1 sequentially to the first touch electrodes ETA1˜ETA5 via the first touch driving circuit 110, while the second touch electrodes ETB1˜ETB5 receive no signal. Thereby, the touch detecting circuit 120 receives a plurality of first detecting signals (e.g., SDT11˜SDT15) from the second touch electrodes ETB1˜ETB5. That is, the touch detecting circuit 120 drives the first touch electrodes ETA1˜ETA5 and the second touch electrodes ETB1˜ETB5 by mutual capacitance detection. Moreover, according to timing of provision of the first driving signal SD1 and the first detecting signals SDT11˜SDT15, the touch detecting circuit 120 determines whether the touch apparatus has sensed a touch point, and the touch point at this moment is viewed as a first touch reference point.

Next, in a second touch detecting period, when the touch detecting circuit 120 detects the first touch reference point, the touch detecting circuit 120 detects capacitance variations of the first touch electrodes ETA1˜ETA5 and the second touch electrodes ETB1˜ETB5 in order to obtain a plurality of second detecting signals (e.g., SDT21˜SDT25) and a plurality of third detecting signals (e.g., SDT31˜SDT35). That is, the touch detecting circuit 120 drives the first touch electrodes ETA1˜ETA5 and the second touch electrodes ETB1˜ETB5 by self capacitance detection. Next, according to the second detecting signals SDT21˜SDT25, the third detecting signals SDT31˜SDT35 and the first touch reference point, the touch detecting circuit 120 determines at least one first real touch point. When the touch detecting circuit 120 does not detect the first touch reference point, the touch detecting circuit 120 may stopped detecting the first touch electrodes ETA1˜ETA5 and the second touch electrodes ETB1˜ETB5. That is, the touch detecting circuit 120 is left idle to save power consumption.

In other words, when the capacitance variations represented by the second detecting signal (e.g., SDT21˜SDT25) and the third detecting signal (e.g., SDT31˜SDT35) corresponding to each first touch reference point are equal to or more than a capacitance threshold, it indicates that the first touch reference point is a real touch point, and the each first touch reference point is saved as the first real touch point. When the capacitance variation represented by one of the second detecting signal (e.g., SDT21˜SDT25) and the third detecting signal (e.g., SDT31˜SDT35) corresponding to each first touch reference point is less than the capacitance threshold, it indicates that the first touch reference point may be noise or a pseudo touch point, and thus, the each first touch reference point is removed.

In the above, the second detecting signal (e.g., SDT21˜SDT25) and the third detecting signal (e.g., SDT31˜SDT35) corresponding to each first touch reference point are respectively the second detecting signal (e.g., SDT21˜SDT25) and the third detecting signal (e.g., SDT31˜SDT35) outputted by the first touch electrodes ETA1˜ETA5 and the second touch electrodes ETB1˜ETB5 corresponding to the each first touch reference point. Moreover, in the second touch detecting period, the touch detecting circuit 120 may completely scanned the first touch electrodes ETA1˜ETA5 and the second touch electrodes ETB1˜ETB5, or the touch detecting circuit 120 may scanned the first touch electrodes ETA1˜ETA5 and the second touch electrodes ETB1˜ETB5 corresponding to the each first touch reference point. The invention is not limited thereto.

According to the above, since mutual capacitance detection has higher touch accuracy while self capacitance detection has higher touch sensitivity, the touch point determined by mutual capacitance detection is re-confirmed by self capacitance detection. Accordingly, sensitivity and accuracy of the touch display apparatus are improved.

In the present embodiment, the first touch driving circuit 110 has a plurality of shift registers (e.g., SA1˜SA5), wherein the shift registers SA1˜SA5 are activated sequentially upon triggering by the start signal STV1, and the activated shift registers (e.g., SA1˜SA5) provide the first driving signal SD1 according to the clock signals CK1 and XCK1. Here, the clock signals CK1 and XCK1 are inverted signals of each other.

The color filter substrate SBC and the active array substrate SBA are assembled together with each other. The pixel array 130 is disposed on the active array substrate SBA and is configured to form the display area. The display driving circuit 140 is disposed on the active array substrate SBA, coupled to the pixel array 130 in order to drive the pixel array 130, and also coupled to the touch detecting circuit 120 in order to provide an operation synchronizing signal SYN to the touch detecting circuit 120. Through the operation synchronizing signal SYN, the display driving circuit 140 and the touch detecting circuit 120 operate synchronously. That is, the first touch detecting period and the second touch detecting period overlap a frame scanning period of the display apparatus.

In the present embodiment, the display driving circuit 140 includes a timing controller 141, a gate driver 143 and a source driver 145, wherein the timing controller 141 is configured to control the gate driver 143 and the source driver 145, the gate driver 143 is configured to drive a pixel P in the pixel array 130 row by row, and the source driver 145 is configured to write image data in the driven pixel P. Moreover, the gate driver 143 includes a plurality of shift registers. However, embodiments of the invention are not limited thereto.

According to the above, since a circuit or element having a more complicated structure is directly formed on the active array substrate SBA, and a circuit or element having a simpler structure is formed on the color filter substrate SBC, fabrication complexity of the touch display apparatus is prevented from increasing, so that manufacturing cost of the touch display apparatus is reduced.

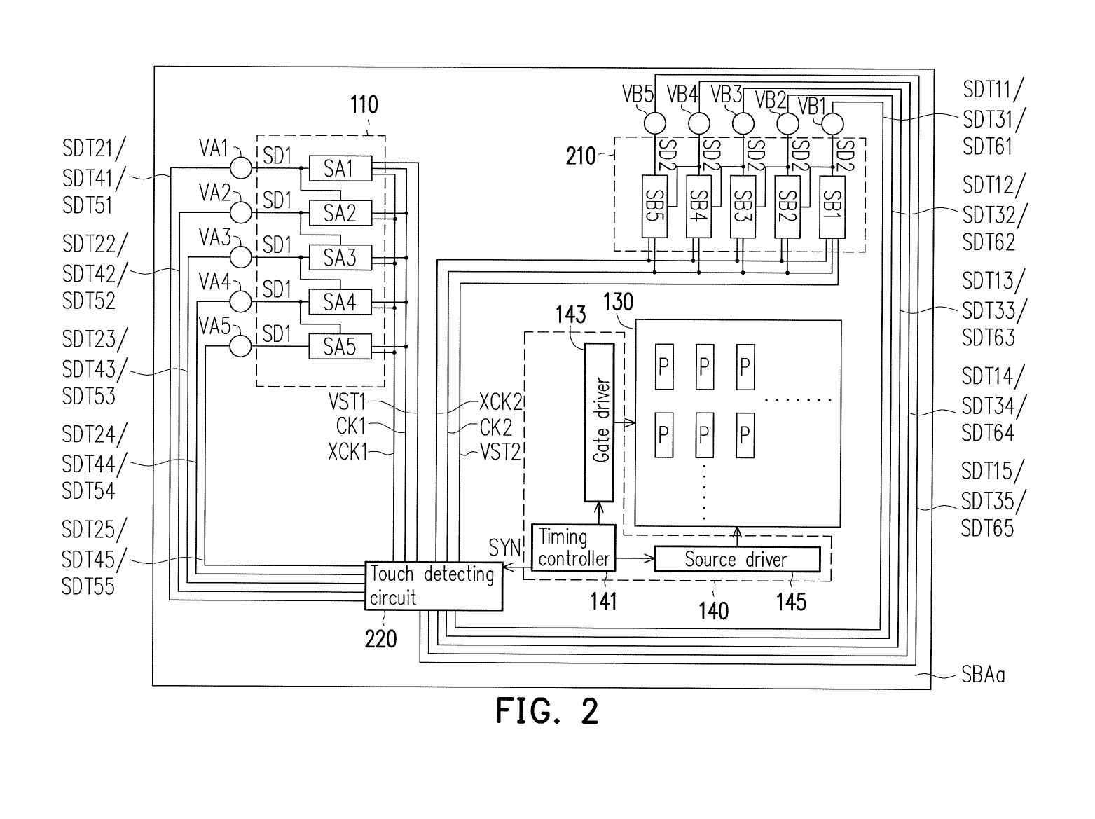

FIG. 2 is a schematic diagram of a structure of an active array substrate according to another embodiment of the invention. Referring to FIG. 1A and FIG. 2, wherein the same or similar elements are denoted by the same or similar reference numerals. A difference therebetween lies in that the touch apparatus further includes a second touch driving circuit 210, and the second touch driving circuit 210 is coupled to a touch detecting circuit 220. The second touch driving circuit 210 includes a plurality of shift registers (e.g., SB1˜SB5), and the shift registers SB1˜SB5 are coupled to the second touch electrodes ETB1˜ETB5 by the vias VB1˜VB5. In the present embodiment, the shift registers SB1˜SB5 are activated sequentially upon triggering by a start signal STV2 provided by the touch detecting circuit 220, and the activated shift registers (e.g., SB1˜SB5) provide a second driving signal SD2 according to clock signals CK2 and XCK2 provided by the touch detecting circuit 220. Here, the clock signals CK2 and XCK2 are inverted signals of each other.

Furthermore, in a first touch detecting period, the touch detecting circuit 220 provides the first driving signal SD1 sequentially to the first touch electrodes ETA1˜ETA5 via the first touch driving circuit 110 in order to receive a plurality of first detecting signals (e.g., SDT11˜SDT15) from the second touch electrodes ETB1˜ETB5. That is, the touch detecting circuit 220 drives the first touch electrodes ETA1˜ETA5 and the second touch electrodes ETB1˜ETB5 by mutual capacitance detection. Moreover, according to timing of provision of the first driving signal SD1 and the first detecting signals SDT11˜SDT15, the touch detecting circuit 220 determines whether the touch apparatus has sensed the first touch reference point.

Next, in a second touch detecting period, when the touch detecting circuit 220 detects the first touch reference point, the touch detecting circuit 220 detects capacitance variations of the first touch electrodes ETA1˜ETA5 and the second touch electrodes ETB1˜ETB5 in order to obtain a plurality of second detecting signals (e.g., SDT21˜SDT25) and a plurality of third detecting signals (e.g., SDT31˜SDT35). That is, the touch detecting circuit 220 drives the first touch electrodes ETA1˜ETA5 and the second touch electrodes ETB1˜ETB5 by self capacitance detection. Next, according to the second detecting signals SDT21˜SDT25, the third detecting signals SDT31˜SDT35 and the first touch reference point, the touch detecting circuit 220 determines at least one first real touch point.

In a third touch detecting period, the touch detecting circuit 220 provides the second driving signal SD2 sequentially to the second touch electrodes ETB1˜ETB5 via the second touch driving circuit 210 in order to receive a plurality of fourth detecting signals (e.g., SDT41˜SDT45) from the first touch electrodes ETA1˜ETA5. Moreover, according to timing of provision of the second driving signal SD2 and the fourth detecting signals SDT41˜SDT45, the touch detecting circuit 220 determines whether the touch apparatus has sensed a second touch reference point.

Next, in a fourth touch detecting period, when the touch detecting circuit 220 detects the second touch reference point, the touch detecting circuit 220 detects the capacitance variations of the first touch electrodes ETA1˜ETA5 and the second touch electrodes ETB1˜ETB5 in order to obtain a plurality of fifth detecting signals (e.g., SDT51˜SDT55) and a plurality of sixth detecting signals (e.g., SDT61˜SDT65). Next, according to the fifth detecting signals SDT51˜SDT55, the sixth detecting signals SDT61˜SDT65 and the second touch reference point, the touch detecting circuit 220 determines at least one second real touch point.

In the present embodiment, the first touch driving circuit 110 and the second touch driving circuit 210 are alternately activated in order to detect a touch point of the touch apparatus. Moreover, the first touch detecting period and the second touch detecting period overlap a frame scanning period of the display apparatus, and the third touch detecting period and the fourth touch detecting period overlap another frame scanning period of the display apparatus.

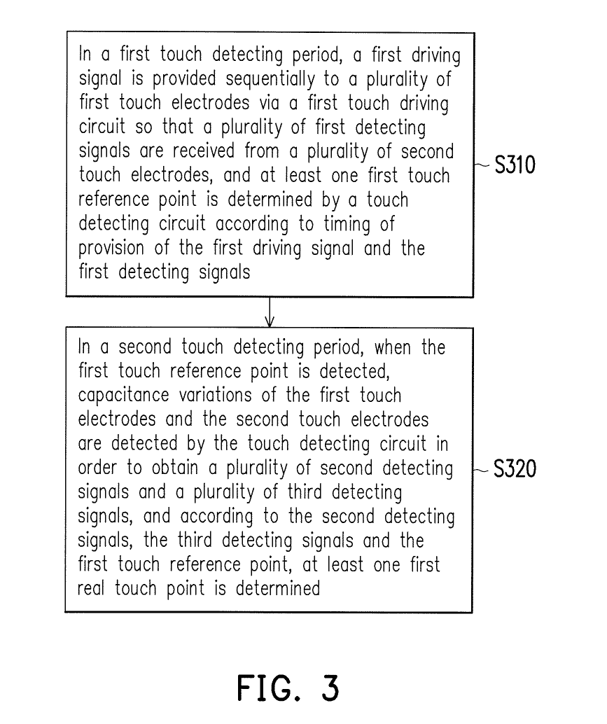

FIG. 3 is a flow chart of a method for detecting a touch point of a touch display apparatus according to an embodiment of the invention. Referring to FIG. 3, in the present embodiment, the method for detecting a touch point of a touch display apparatus at least includes the following steps. In a first touch detecting period, a first driving signal is provided sequentially to a plurality of first touch electrodes via a first touch driving circuit so that a plurality of first detecting signals are received from a plurality of second touch electrodes, and at least one first touch reference point is determined by a touch detecting circuit according to timing of provision of the first driving signal and the first detecting signals (step S310), wherein the first touch electrodes and the second touch electrodes are interlaced with each other to form a touch area.

In a second touch detecting period, when the first touch reference point is detected, capacitance variations of the first touch electrodes and the second touch electrodes are detected by the touch detecting circuit in order to obtain a plurality of second detecting signals and a plurality of third detecting signals, and according to the second detecting signals, the third detecting signals and the first touch reference point, at least one first real touch point is determined (step S320). The above order of steps 5310 and S320 is for illustrative purposes and embodiments of the invention are not limited thereto. Moreover, the details of steps S310 and S320 are as shown in FIG. 1A, FIG. 1B and FIG. 2, and will be omitted herein.

In summary, in the touch display apparatus and the method for detecting a touch point thereof according to embodiments of the invention, firstly, a touch point is determined by mutual capacitance detection, and then whether the touch point is a real touch point is confirmed by self capacitance detection. Accordingly, sensitivity and accuracy of the touch display apparatus are improved. Moreover, a circuit or element having a more complicated structure is directly formed on the active array substrate, and a circuit or element having a simpler structure is formed on the color filter substrate. Accordingly, fabrication complexity of the touch display apparatus is prevented from increasing, so that manufacturing cost of the touch display apparatus is reduced.

Although the invention has been described with reference to the above embodiments, it will be apparent to persons of ordinary skill in the art that modifications to the described embodiments may be made without departing from the spirit of the invention. Accordingly, the scope of the invention will be defined by the attached claims and not by the above detailed descriptions.

What is claimed is:

1. A touch display apparatus, comprising:
a display apparatus; and
a touch apparatus, comprising:
a plurality of first touch electrodes and a plurality of second touch electrodes, interlaced with each other to form a touch area, wherein the touch area overlaps a display area of the display apparatus;
a first touch driving circuit coupled to the first touch electrodes; and
a touch detecting circuit coupled to the first touch electrodes, the second touch electrodes and the first touch driving circuit, and controlling the first touch driving circuit;
wherein in a first touch detecting period, the touch detecting circuit provides a first driving signal sequentially to the first touch electrodes via the first touch driving circuit in order to receive a plurality of first detecting signals from the second touch electrodes, and the touch detecting circuit determines at least one first touch reference point according to timing of provision of the first driving signal and the first detecting signals,
in a second touch detecting period, when the touch detecting circuit detects the at least one first touch reference point, the touch detecting circuit detects capacitance variations of the first touch electrodes and the second touch electrodes in order to obtain a plurality of second detecting signals and a plurality of third detecting signals, so as to determine at least one first real touch point according to the second detecting signals, the third detecting signals and the at least one first touch reference point.

2. The touch display apparatus of claim 1, wherein the first touch electrodes and the second touch electrodes are perpendicular to and interlaced with each other.

3. The touch display apparatus of claim 1, wherein the first touch detecting period and the second touch detecting period overlap a frame scanning period of the display apparatus.

4. The touch display apparatus of claim 1, wherein when the capacitance variations represented by the second detecting signal and the third detecting signal corresponding to each of the first touch reference points are equal to or more than a capacitance threshold, the each of the first touch reference points is saved as each of the first real touch points, and when the capacitance variation represented by one of the second detecting signal and the third detecting signal corresponding to each of the first touch reference points is less than the capacitance threshold, the each of the first touch reference points is removed, wherein the second detecting signal and the third detecting signal corresponding to the each of the first touch reference points are respectively the second detecting signal and the third detecting signal outputted by the first touch electrode and the second touch electrode corresponding to the each of the first touch reference points.

5. The touch display apparatus of claim 1, wherein the display apparatus comprises:
an active array substrate;
a color filter substrate, assembled together with the active array substrate;
a pixel array, disposed on the active array substrate and configured to form the display area; and
a display driving circuit, disposed on the active array substrate, and coupled to the pixel array in order to drive the pixel array.

6. The touch display apparatus of claim 5, wherein the first touch driving circuit is disposed on the active array substrate, and the first touch electrodes and the second touch electrodes are disposed on the color filter substrate.

7. The touch display apparatus of claim 6, wherein the display driving circuit and the first touch driving circuit each include a plurality of shift registers.

8. The touch display apparatus of claim 5, wherein the display driving circuit provides an operation synchronizing signal to the touch detecting circuit.

9. The touch display apparatus of claim 1, further comprising:
a second touch driving circuit coupled to the second touch electrodes;
wherein in a third touch detecting period, the touch detecting circuit provides a second driving signal sequentially to the second touch electrodes via the second touch driving circuit in order to receive a plurality of fourth detecting signals from the first touch electrodes, and the touch detecting circuit determines at least one second touch reference point according to timing of provision of the second driving signal and the fourth detecting signals,
in a fourth touch detecting period, when the touch detecting circuit detects the at least one second touch reference point, the touch detecting circuit detects the capacitance variations of the first touch electrodes and the second touch electrodes in order to obtain a plurality of fifth detecting signals and a plurality of sixth detecting signals, so as to determine at least one second real touch point according to the fifth detecting signals, the sixth detecting signals and the at least one second touch reference point.

10. A method for detecting a touch point of a touch display apparatus, comprising:
in a first touch detecting period, providing a first driving signal sequentially to a plurality of first touch electrodes via a first touch driving circuit in order to receive a plurality of first detecting signals from a plurality of second touch electrodes, and determining at least one first touch reference point by a touch detecting circuit according to timing of provision of the first driving signal and the first detecting signals, wherein the first touch electrodes and the second touch electrodes are interlaced with each other to form a touch area; and
in a second touch detecting period, when detecting the at least one first touch reference point, detecting capacitance variations of the first touch electrodes and the second touch electrodes by the touch detecting circuit in order to obtain a plurality of second detecting signals and a plurality of third detecting signals, and determining at least one first real touch point according to the second detecting signals, the third detecting signals and the at least one first touch reference point.

11. The method for detecting a touch point of a touch display apparatus of claim 10, wherein the first touch detecting period and the second touch detecting period overlap a frame scanning period of a display apparatus of the touch display apparatus.

12. The method for detecting a touch point of a touch display apparatus of claim 10, wherein when the capacitance variations represented by the second detecting signal and the third detecting signal corresponding to each of the first touch reference points are equal to or more than a capacitance threshold, the each of the first touch reference points is saved as each of the first real touch points, and when the capacitance variation represented by one of the second detecting signal and the third detecting signal corresponding to each of the first touch reference points is less than the capacitance threshold, the each of the first touch reference points is removed, wherein the second detecting signal and the third detecting signal corresponding to the each of the first touch reference points are respectively the second detecting signal and the third detecting signal outputted by the first touch electrode and the second touch electrode corresponding to the each of the first touch reference points.

13. The method for detecting a touch point of a touch display apparatus of claim 10, further comprising:
in a third touch detecting period, providing a second driving signal sequentially to the second touch electrodes via a second touch driving circuit in order to receive a plurality of fourth detecting signals from the first touch electrodes, and determining at least one second touch reference point by the touch detecting circuit according to timing of provision of the second driving signal and the fourth detecting signals; and
in a fourth touch detecting period, when detecting the at least one second touch reference point, detecting the capacitance variations of the first touch electrodes and the second touch electrodes by the touch detecting circuit in order to obtain a plurality of fifth detecting signals and a plurality of sixth detecting signals, and determining at least one second real touch point according to the fifth detecting signals, the sixth detecting signals and the at least one second touch reference point.
